(19) United States
(12) Patent Application Publication
(10) Pub. No.: US 2013/0273459 A1
(43) Pub. Date: Oct. 17, 2013

(54) Ionic Conductive Chromophores and Nonaqueous Redox Flow Batteries

(71) Applicant: BATTELLE MEMORIAL INSTITUTE, Richland, WA (US)

(72) Inventors: Wu Xu, Richland, WA (US); Lelia Cosimbescu, Richland, WA (US); Xiaoliang Wei, Richland, WA (US); Wei Wang, Kennewick, WA (US); Vincent L. Sprenkle, Richland, WA (US)

(21) Appl. No.: 13/912,516

(22) Filed: Jun. 7, 2013

Related U.S. Application Data
(63) Continuation-in-part of application No. 13/439,083, filed on Apr. 4, 2012.

(51) Int. Cl. H01M 8/18; H01M 8/20

(52) U.S. Cl. CPC H01M 8/188; H01M 8/20
USPC 429/498

(57) ABSTRACT

Ionic conductive chromophores can be used as the positive electrolytes for high-energy density, nonaqueous redox flow battery (NRFB) systems. The nonaqueous nature of the NRFB systems allow for high operation voltage (compared to aqueous systems). Furthermore, the structure modifications to chromophores described herein improve the solubility of the resultant ionic conductive chromophores, thereby allowing them to be used in flow cell configurations.

### CROSS-REFERENCE TO RELATED APPLICATIONS

This invention claims priority from, and is a continuation in part of, currently pending patent application Ser. No. 13/439,083, filed Apr. 4, 2012, and entitled, Hybrid Energy Storage System Utilizing Redox Active Organic Compounds. The application is incorporated herein by reference.

### STATEMENT REGARDING FEDERALLY SPONSORED RESEARCH OR DEVELOPMENT

This invention was made with Government support under Contract DE-ACO576RLO1830 awarded by the U.S. Department of Energy. The Government has certain rights in the invention.

### BACKGROUND

Redox flow battery (RFB) and hybrid-RFB systems have many advantages over their solid state counterparts such as the separation of power and energy, the ability to reach up to MWh energy storage, thermal safety, quick response, etc. Traditional RFB systems typically utilize aqueous chemistries. However, aqueous RFBs can be associated with low energy density due to their low operation voltage, which is limited by the water electrolysis voltage window. Non-aqueous RFB systems can exhibit improved energy density because of increased operation voltages, but the solubility of the active material tends to be very low (often times less than 0.1 M). Together with unwanted side reactions, which are common in nonaqueous systems, the low active material concentration results in inferior electrochemical performance in state-of-the-art RFB systems.

Therefore, a need exists for non-aqueous RFB systems having sufficiently high active material concentrations and relatively high energy densities.

### SUMMARY

This document describes nonaqueous RFBs having high operational voltages and having positive electrolytes that are highly soluble compared to conventional electrolytes. Accordingly, the nonaqueous RFBs exhibit improved performance and greater energy densities compared to traditional aqueous and even other nonaqueous RFBs.

In one embodiment, a nonaqueous RFB system comprises a catholyte in a positive half-cell separated by a separator from a negative half-cell. The catholyte comprises an ionic conductive chromophore as a catholyte redox active species. The concentration of the ionic conductive chromophore in the nonaqueous catholyte solution is at least 0.1 M. In some embodiments, the concentration of ionic conductive chromophores is at least 0.2 M. In other embodiments, the concentration of the ionic conductive chromophore is at least 0.5 M.

As used herein, ionic conductive chromophores can refer to chromophores into which solubility-enhancing ionic moieties can be incorporated. Chromophore typically refers herein to a colored, conductive compound that possesses a high degree of conjugation. As used herein, the chromophore includes the chemical moiety capable of at least one electron transfer (reduction), and it is typically a fused aromatic ring system, which by itself has a relatively low solubility. Examples of chromophores that can be modified with a solubility-enhancing ionic moiety include those chromophores having an electron deficient ring system. In some embodiments, such chromophores include, but are not limited to, those shown in FIGS. 3A-3V.

Incorporation of a solubility-enhancing ionic moiety enables the attainment of useful concentrations for redox flow battery applications. This can be achieved by bonding the ionic moiety to the chromophore directly, or through various chemical groups which can be part of the chromophore. The moiety can be part of a conductive ionic pair, which can be designed such that the positive charge belongs to the chromophore and the appended counterion is negatively charged. Examples of negatively charged counter ions can include, but are not limited to, bis[(trifluoromethane sulfonyl)amide] (TFSI), bis(fluorosulfonyl)imde (FSI⁻), bis(pentafluoroethanesulfonyl)imide (BETI⁻), (fluorosulfonyl) (trifluoromethanesulfonyl)imide (FTI⁻), hexafluorophosphate (PF₆⁻), tetrabluoroborate (BF₄⁻), hexafluoroarsenate (AsF₆⁻), perchlorate (ClO₄⁻), dicyanoamide (N(CN)₂⁻), trifluoromethanesulfonate (CF₃SO₃⁻), bis(oxalate)borate (BOB⁻), difluoro oxalatoborate (DFOB⁻), and combinations thereof. Alternatively, the negative charge can reside on the connecting group of the chromophore, while the counterion can be the positive species. Examples of negatively charged species that can reside on the chromophore part include but are not limited to sulfate, sulfonate, phosphate, phosphite, phosphonate, sulfide, oxide, carboxylate, nitrate. Examples of positively charged counterions include but are not limited to metal ions, pyridinium, ammonium, imidazolium, pyrrolidinium, piperidinium, phosphonium, sulfonium groups. In preferred embodiments, the solubility-enhancing ionic moiety comprises sulfur, nitrogen, phosphorous, or combinations thereof. Examples of such ionic conductive chromophores having the structural modifications described herein can include, but are not limited to, those shown in FIGS. 4A-4R.

In one embodiment, the NRFB system can comprise flow cells as both the negative as well as the positive half cells of the system. A negative half-cell can comprise an anolyte in a nonaqueous anolyte solution as an anolyte redox active species. The concentration of the anolyte is at least 0.1 M. In some instances, the anolyte can comprise transition metals and metal ions. For example, the anolyte can comprise chromium and can yield Cr²⁺/Cr³⁺ or Cr⁺/Cr²⁺ anolyte redox couples. Alternatively, the anolyte can comprise vanadium and can yield V²⁺/V³⁺ as an anolyte redox couple. The positive half-cell can comprise a catholyte in a nonaqueous catholyte solution. The catholyte comprises an ionic conductive chromophore as a catholyte redox active species. The system can include a catholyte source and an anolyte source from which the catholyte and the anolyte flow through the positive and negative half-cells.

In other embodiments, the RFB system can comprise a hybrid flow configuration having a flow cell as the positive half-cell and a solid, or semi-flowable, material as the negative half-cell. For example, the negative half-cell can have an anode comprising lithium, sodium, magnesium, or aluminum metal. The active species in such instances can comprise Li/Li⁺, Na/Na⁺, Mg/Mg²⁺, or Al/Al³⁺, respectively. The positive half-cell can comprise a catholyte in a nonaqueous catholyte solution. The catholyte comprises an ionic conductive chromophore as a catholyte redox active species. The system can include a catholyte source from which the catholyte flows through the positive half-cell.

In yet another embodiment, an NRFB system can further comprise a plurality of flow cells, each flow cell formed between two electrodes and having the positive half-cell and the negative half-cell separated by the separator or ionic exchanged membranes (IEMs). The positive half-cell is a flow cell. The negative half-cell can be a flow cell or a static cell. Accordingly, individual flow cells can be joined in a stack.

In one embodiment, a NRFB system comprises a catholyte in a positive half-cell separated by a separator/IEM from an anolyte in a negative half-cell. The catholyte comprises an ionic conductive chromophore having a solubility-enhancing ionic moiety comprising sulfur, nitrogen, and/or phosphorous and is in a nonaqueous catholyte solution as a catholyte redox active species at a concentration of at least 0.2 M. The anolyte is in a nonaqueous anolyte solution as an anolyte redox active species. The concentration of the anolyte in the solution can be at least 0.2 M.

In another embodiment, a NRFB system comprises a catholyte in a positive half-cell separated by a separator/IEM from a negative half-cell having an anode comprising lithium, sodium, or magnesium and the catholyte comprises an ionic conductive chromophore having a solubility-enhancing ionic moiety comprising sulfur, nitrogen, and/or phosphorous and is in a nonaqueous catholyte solution as a catholyte redox active species at a concentration of at least 0.2 M.

The purpose of the foregoing summary is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The summary is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions, the various embodiments, including the preferred embodiments, have been shown and described. Included herein is a description of the best mode contemplated for carrying out the invention. As will be realized, the invention is capable of modification in various respects without departing from the invention. Accordingly, the drawings and description of the preferred embodiments set forth hereafter are to be regarded as illustrative in nature, and not as restrictive.

### DESCRIPTION OF DRAWINGS

Embodiments of the invention are described below with reference to the following accompanying drawings.

FIG. 1 is a schematic depicting a hybrid NRFB system according to embodiments described herein.

FIG. 2 is a schematic depicting a NRFB system according to embodiments described herein.

FIGS. 3A-3V include non-limiting depictions of various conductive chromophores that can be modified with solubility enhancing ionic moieties according to embodiments described herein.

FIG. 4A-4R include non-limiting depictions of various ionic conductive chromophores according to embodiments described herein.

### DETAILED DESCRIPTION

The following description includes the preferred best mode of one embodiment of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

Ionic conductive chromophores can be used as the positive electrolytes for high-energy density, nonaqueous RFB systems. The nonaqueous nature of the NRFB systems allow for high operation voltage (compared to aqueous systems). Furthermore, the structure modifications of the chromophores described herein improve the solubility of the resultant ionic conductive chromophores, thereby allowing them to be used in flow cell and/or hybrid flow cell configurations.

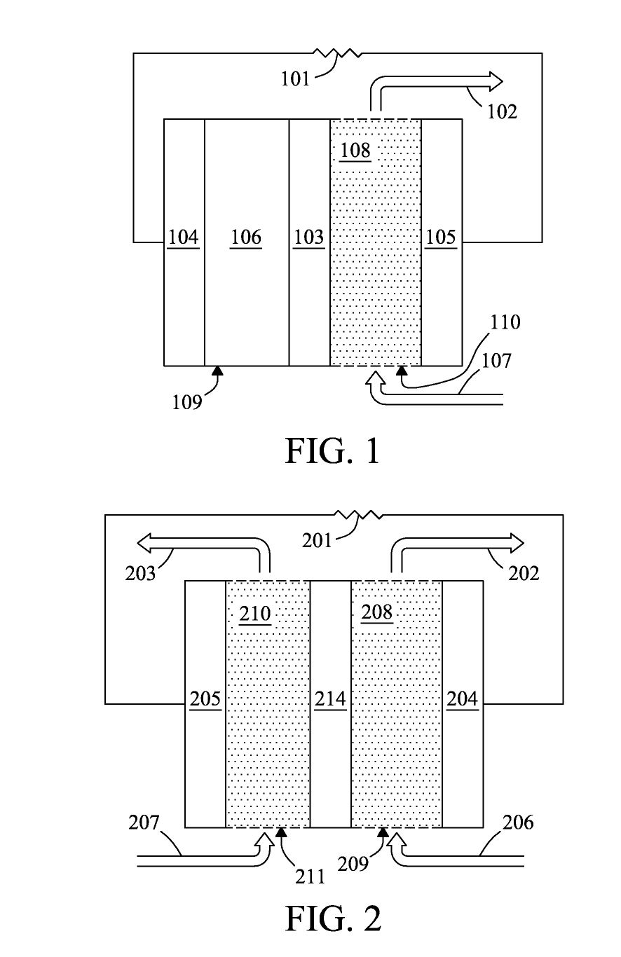

FIGS. 1-4 show a variety of aspects and embodiments of the present invention. Referring first to FIG. 1, a schematic diagram depicts one embodiment in which the negative half-cell 109 has an anode material 106 that is a solid and comprises a redox active metal. The anode material is in electrical contact with a load 101 through an optional negative current collector 104. The negative half-cell 109 is separated from the positive half-cell 110 by a separator 103. The positive half-cell 110 comprises a redox active ionic conductive chromophore dissolved in a non-aqueous catholyte solution 108. The positive active material is in electrical contact with the load 101 through the positive current collector 105. The positive active material can be flowed to a first volume from a source 107 in a batch or continuous manner. The catholyte exits the positive half-cell volume by pathway 102.

FIG. 2 is a diagram of an energy storage system in which both electrodes comprise flowable active materials. The positive half-cell 209 comprises an ionic conductive chromophore dissolved in a non-aqueous catholyte solution 208. The negative half-cell 211 comprises a redox active metal that is either an ion dissolved in a non-aqueous liquid 210 or particles of a solid metal (not illustrated) mixed with a non-aqueous liquid in a flowable suspension 210. The positive and negative active materials can flow into the positive and negative half-cell volumes from separate sources 206 and 207, respectively. The active materials flow out of the positive and negative half-cell volumes through pathways 202 and 203, respectively. As described earlier, in some embodiments, a reservoir (not shown) can be arranged to store the active materials. Flow through the positive half cell, the negative half cell, or both can be continuous or batch in nature. A separator or membrane 214 separates the positive and negative half-cells. As illustrated, the energy storage system can be connected to a load 201 through positive and negative current collectors 204 and 205, respectively.

In the flow and hybrid flow configurations, the separator/membrane and current collectors can comprise materials known in the art. For example, the separator can be a polymer, a ceramic, ionic exchange membrane, and/or an ion permeable membrane. The electrodes can comprise carbon felts, metal felts, and/or metal meshes. The current collectors can comprise carbon or metal conductive plates.

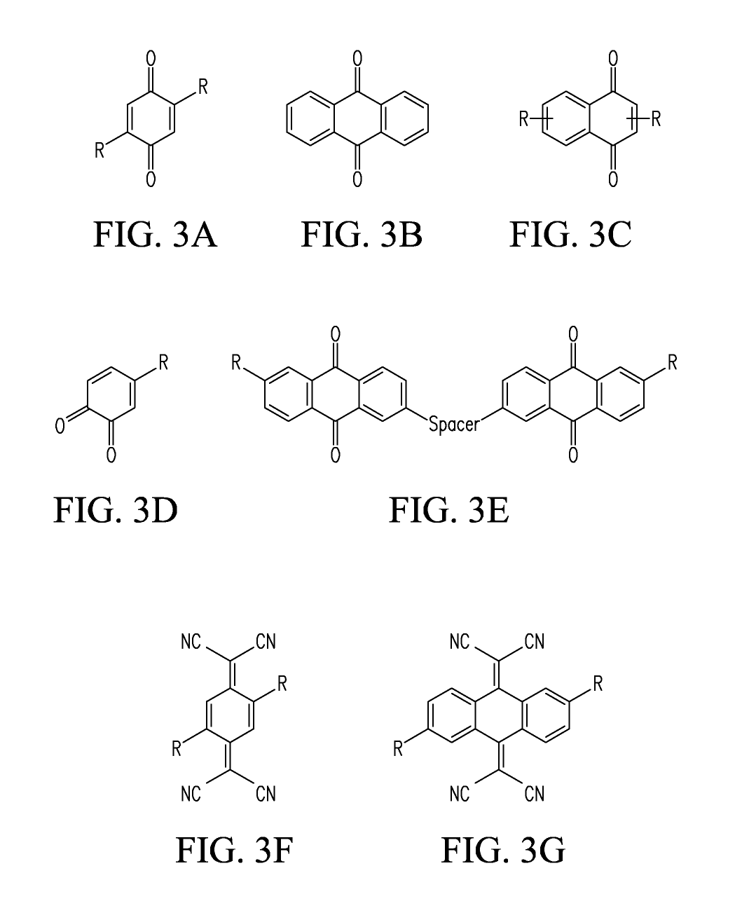

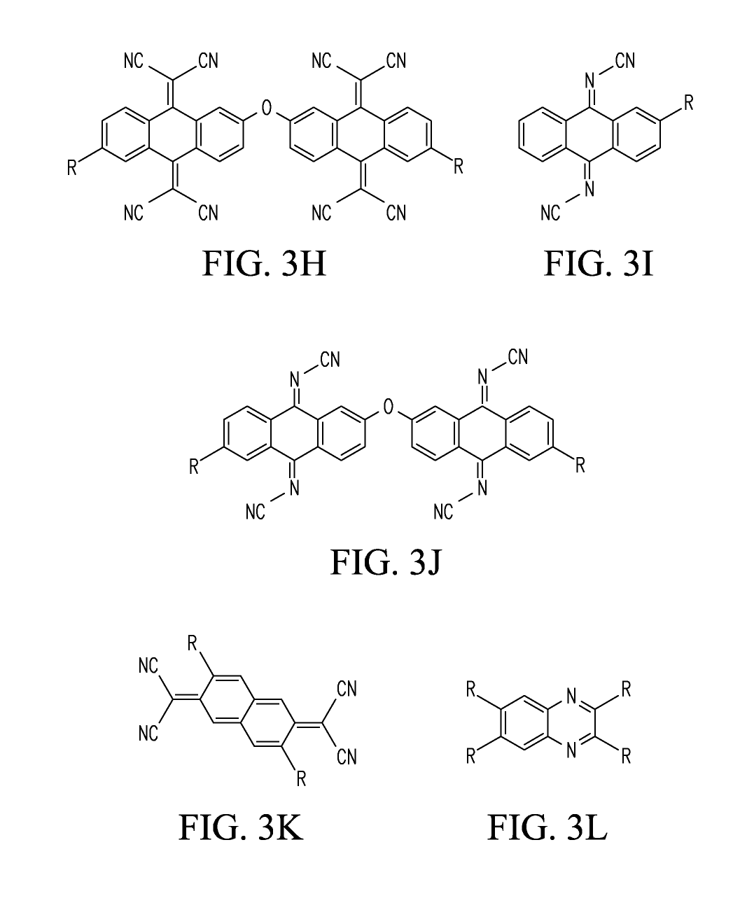

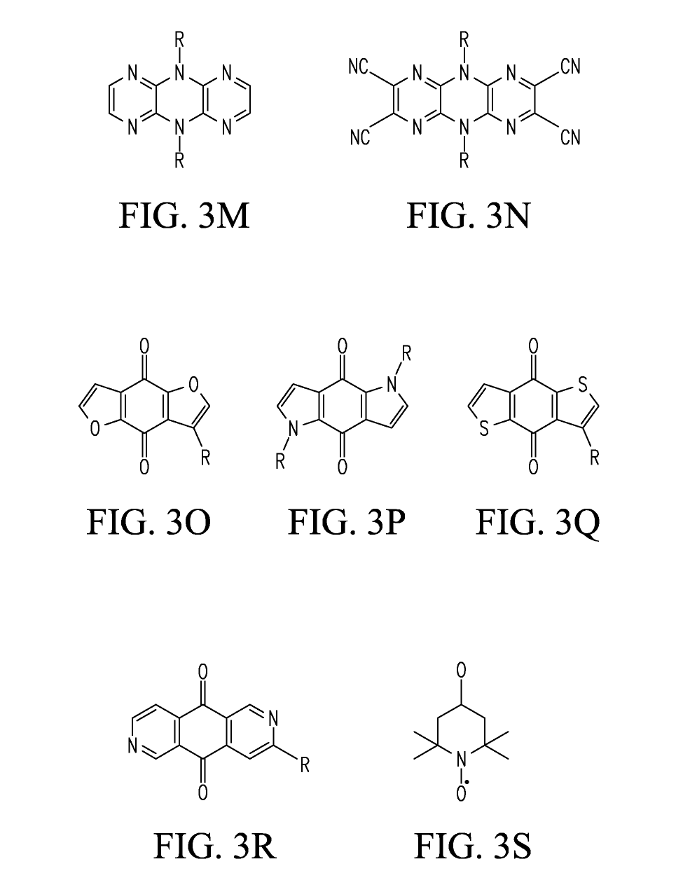

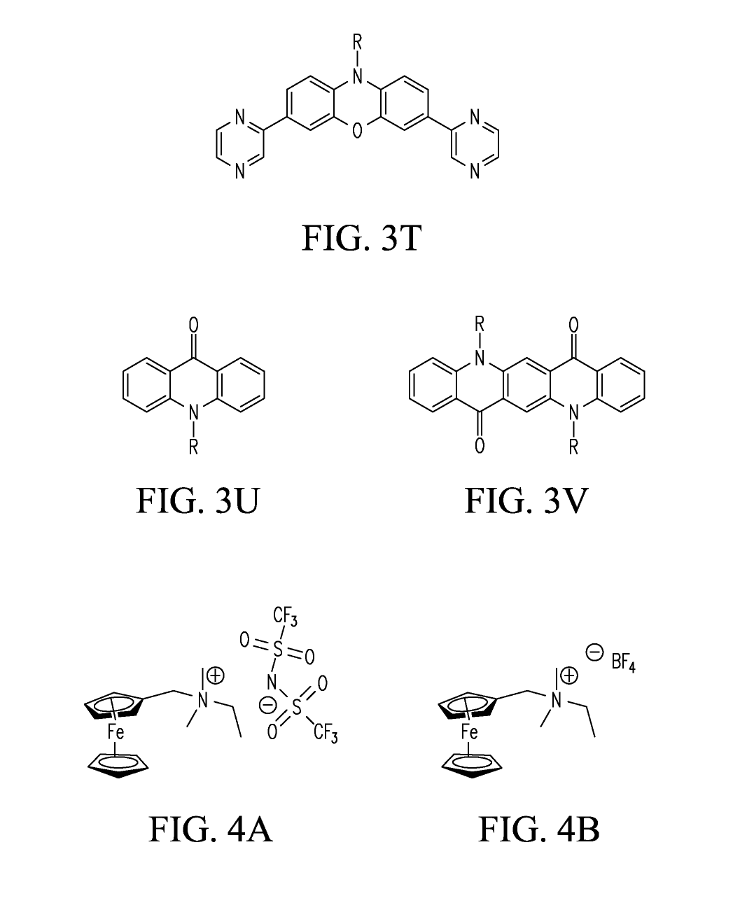

Conventional chromophores can potentially act as catholytes and be very stable both electrochemically and thermally. However their use has been limited by their poor solubility in nonaqueous solvents. In order to increase their solubility, conventional chromophores can be structurally modified to yield ionic conductive chromophores. For example, a ferrocene compound can be modified to increase its solubility by approximately ten times by incorporating a solubility-enhancing ionic moiety into the ferrocene structure. Similar improvements can be obtained for other chromophores. Several examples of achieving such improvements include, but are not limited to attaching a tertiary amine group, a substituted imine group, a phosphonium ion or sulfonium ion group. Examples of chromophores that are suitable for modification to improve solubility according to embodiments of the present invention include, but are not limited to those depicted in FIGS. 3A-3V.

The chromophores depicted in FIGS. 3A-3V are electron acceptors and can have useful redox potentials. “R” represents any group that can be introduced in the structure and that carries a chemical functionality amenable to ionic liquid formation. Examples can include, but are not limited to, an sp3 hybridized nitrogen, an sp2 hybridized nitrogen, a phosphorus or a sulfur atom that can lead to an ammonium ion, an iminium ion, a phosphonium or a sulfonium ion, respectively. The positively charged conductive center, whether comprising sulfur, nitrogen or phosphorus, can be a substituent attached to the ring or an integral part of the ring. The position of the R group about the ring is not limited to those depicted in FIGS. 3A-3V, but can be in various positions in the structure.

The chromophores can be linked to form dimers, trimers and tetramers, with the aid of a spacer. Spacers can be an atom or a chemical group. Examples of atoms can include, but are not limited to 0, S, P, N, C, and Si. Examples of chemical groups can include, but are not limited to, a ring or a groups of fused rings (phenyl, heterocyclic, saturated or unsaturated ring structure) that can themselves be further substituted, CR¹R², NR³, PR⁴, PR⁵R⁶R⁷and SiR⁸R⁹, where R¹-R⁹ are hydrogen, alkyl, alkenyl, aryl, halogenated alkyl, halogenated alkenyl, halogenated aryl, and all of these alkyl or alkenyl or aryl groups may further contain N, O, S, P, and Si. Other useful groups are ethylene glycol or polyethylene glycols.

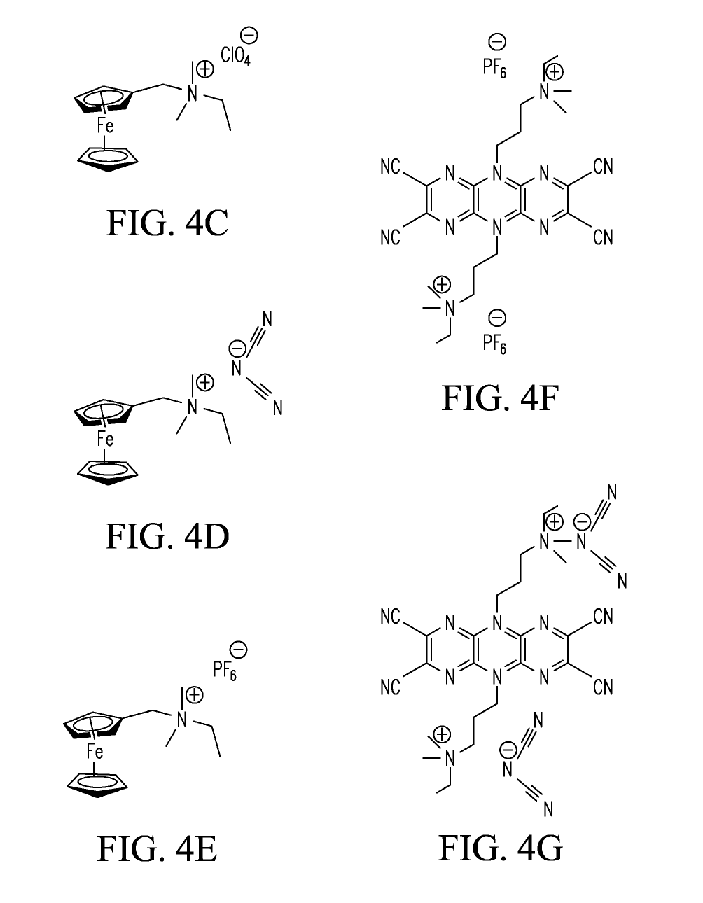

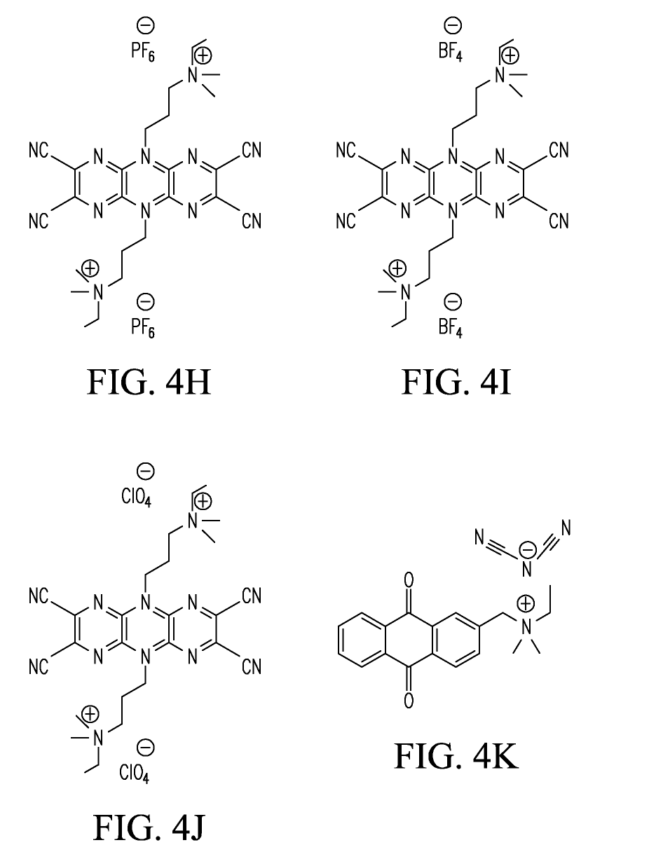

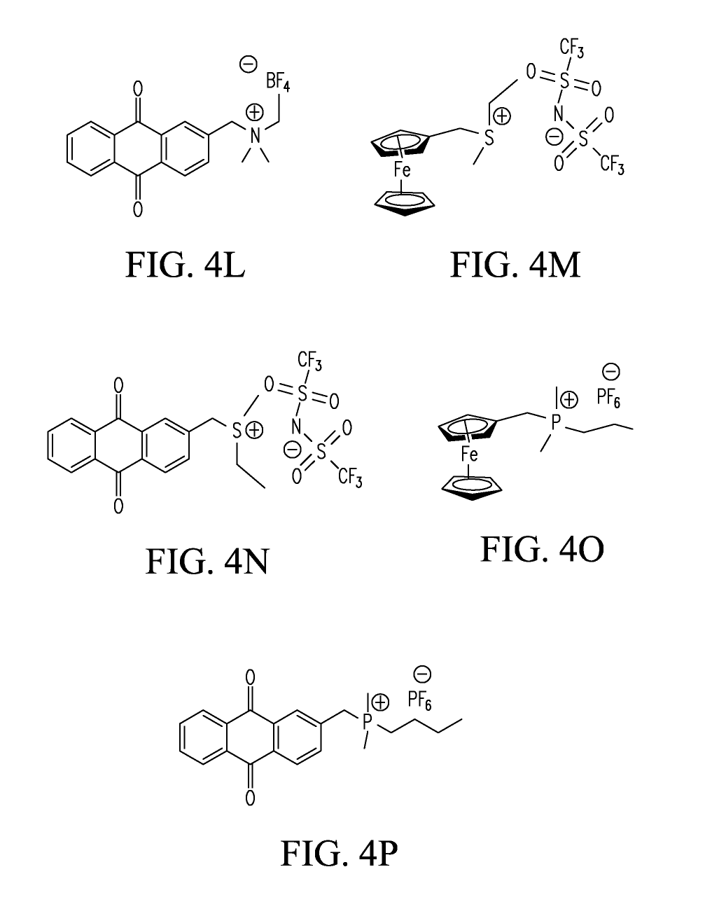

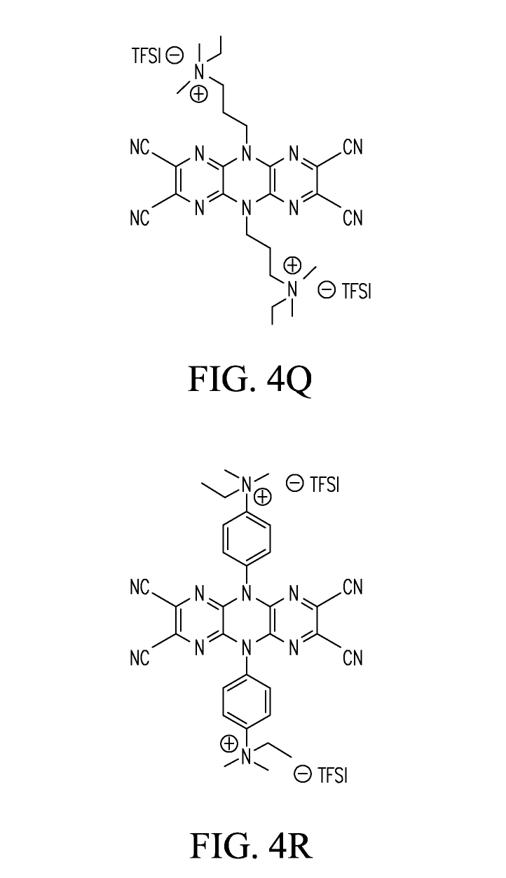

Aside from the group that contains the moiety able to yield an ionic liquid, other substituents can be present in the molecule, and they can be any substituent other than hydrogen. Suitably, the substituent may be bonded to the remainder of the molecule via a carbon, silicon, phosphorus, nitrogen, oxygen. The substituent may be halogen, cyano, hydroxyl, carboxy, nitro, amino, or groups which may be further substituted such as alkyl, alkoxy, straight or branched, saturated or unsaturated, cyclic rings, aromatic 5 member rings or higher aromatic system, fused or non-fused, carbonamido, sulfonamido, sulfonyl, thio, acyloxy, amino, imino, phosphate, a heterocyclic group, an oxo heterocyclic group, silyloxy. If desired, the rings can be further substituted with substituent groups. The particular substituents used, can be selected to introduce or enhance desired properties for a given application. Examples can include, but are not limited to, electron withdrawing, electron donating and steric groups. When a molecule has 2 or more substituents, the substituents can be joined together to form a ring. Some examples of ionic conductive chromophores having the structure modifications described herein are depicted in FIG. 4A-4R.

The conductive chromophores described above can be transformed into an ionic conductive chromophore by modifying them to incorporate a solubility-enhancing ionic moiety and appending an appropriate counter ion. In one embodiment, a structure-modified ferrocene ionic liquid (Fc-IL) was used in the positive electrolyte solution for high energy density, nonaqueous hybrid RFBs. The Fc-IL comprised an ionic conductive ferrocene associated with a TFSI counter ion to form an ionic liquid (e.g., Fc-TFSI IL). The ionic conductive ferrocene functioned as the organic active species in the positive half-cell. The negative half-cell comprised a lithium metal anode. The electrolyte solution comprised 1 M Fc-TFSI IL dissolved in 1.5 M LiTFSI-PC. The preliminary cyclic voltammetric (CV) test and the high solubility of the organic active species resulted in a charge/discharge at the average voltage of ˜3.6 V vs. Li/Li⁺, which is much higher than voltage values reported for traditional RFBs.

The Fc-IL as the positive electrolyte or catholyte for a non-aqueous hybrid redox flow battery provides not only a high voltage (about 3.6 V) but also a greatly improved solubility (˜1.1 M). The combination of these advantages can yield the active redox species with a potential to reach an energy density of ˜80 Wh/L at 0.85 M Fc-IL in 1.2 M LiTFSI/PC/EMC (4:1:5) electrolyte or even ˜140 Wh/L at 1.5 M Fc-IL in 2.0 M LiTFSI/PC electrolyte solutions. The energy density can be optimized by the tailored structure and an optimized electrolyte system.

In another embodiment, a modified pyrazine chromophore can be used as the active chromophore. Two examples include, but are not limited to, the structures shown in FIGS. 4Q and 4R.

In yet another embodiment, an ionic conductive chromophore can be used in the positive electrolyte solution for a high energy density, nonaqueous RFB. The ionic conductive chromophore functions as the organic active species in the positive half-cell. The negative half-cell can comprise an electrolyte solution having vanadium ions dissolved in an organic acid. Alternatively, the anolyte can comprise other transition metals. For example, the anolyte can be based on chromium. The separator between the negative and positive half-cells can comprise an ion-permeable membrane. For example, the separator can comprise a sulfonated tetrafluoroethylene based fluoropolymer-copolymer.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A nonaqueous redox flow battery (NRFB) system comprising a catholyte in a positive half-cell separated by a separator from a negative half-cell, wherein the catholyte comprises an ionic conductive chromophore as a catholyte redox active species and is in a nonaqueous catholyte solution at a concentration of at least 0.1 M.

2. The NRFB system of claim 1, wherein the ionic conductive chromophore is a chromophore having a solubility-enhancing ionic moiety incorporated therein.

3. The NRFB system of claim 2, wherein the solubility-enhancing ionic moiety is bonded to the chromophore through a chemical group, which is bound to the chromophore.

4. The NRFB system of claim 2, wherein the solubility-enhancing ionic moiety is bonded directly to the chromophore.

5. The NRFB system of claim 2, wherein the solubility-enhancing ionic moiety comprises sulfur, nitrogen, phosphorous, or combinations thereof.

6. The NRFB system of claim 1, wherein the ionic conductive chromophore comprises an electron deficient ring system.

7. The NRFB system of claim 1, wherein the ionic conductive chromophore comprises a compound shown in FIGS. 4A-4R.

8. The NRFB system of claim 1, wherein the ionic conductive chromophore comprises ferrocene.

9. The NRFB system of claim 1, wherein the ionic conductive chromophore comprises a positively charged solubility-enhancing ionic moiety and a negatively charged counter ion.

10. The NRFB system of claim 9, wherein the negatively charged counter ion is selected from the group consisting of bis[(trifluoromethane sulfonyl)amide] (TFSI⁻), bis(fluorosulfonyl)imde (FSI⁻), bis(pentafluoroethanesulfonyl)imide (BETI⁻), (fluorosulfonyl) (trifluoromethanesulfonyl)imide (FTI⁻), hexafluorophosphate (PF₆⁻), tetrabluoroborate (BF₄⁻), hexafluoroarsenate (AsF₆⁻), perchlorate (ClO₄⁻), dicyanoamide (N(CN)₂⁻), trifluoromethanesulfonate (CF₃SO₃⁻), bis(oxalate)borate (BOB⁻), difluoro oxalatoborate (DFOB⁻), and combinations thereof.

11. The NRFB system of claim 1, wherein the ionic conductive chromophore comprises a negatively charged solubility-enhancing ionic moiety and a positively charged counter ion.

12. The NRFB system of claim 11, wherein the negatively charged solubility-enhancing ionic moiety comprises a species selected from the group consisting of sulfate, sulfonate, phosphate, phosphite, phosphonate, sulfide, oxide, carboxylate, nitrate, and combinations thereof.

13. The NRFB system of claim 11, wherein the positively charged counter ion comprises a species selected from the group consisting of metal ions, pyridinium, ammonium, imidazolium, pyrrolidinium, piperidinium, phosphonium, sulfonium groups, and combinations thereof.

14. The NRFB system of claim 1, wherein the concentration of the ionic conductive chromophore is at least 0.2 M.

15. The NRFB system of claim 1, wherein the concentration of the ionic conductive chromophore is at least 0.5 M.

16. The NRFB system of claim 1, wherein the negative half-cell comprises an anolyte in a nonaqueous anolyte solution as an anolyte redox active species at a concentration of at least 0.1 M.

17. The NRFB system of claim 16, wherein the anolyte comprises vanadium.

18. The NRFB system of claim 16, wherein the nonaqueous anolyte solution comprises an organic acid.

19. The NRFB system of claim 1, wherein the negative half-cell has an anode comprising lithium.

20. The NRFB system of claim 1, wherein the negative half-cell has an anode comprising sodium.

21. The NRFB system of claim 1, wherein the negative half-cell has an anode comprising magnesium.

22. The NRFB system of claim 1, further comprising a plurality of flow cells, each flow cell formed between two electrodes and having the positive half-cell and the negative half-cell separated by the separator.

23. A nonaqueous redox flow battery (NRFB) system comprising:
a catholyte in a positive half-cell separated by a separator from an anolyte in a negative half-cell;
the catholyte comprises an ionic conductive chromophore having a solubility-enhancing ionic moiety comprising sulfur, nitrogen, and/or phosphorous and is in a nonaqueous catholyte solution as a catholyte redox active species at a concentration of at least 0.2 M; and
the anolyte is in a nonaqueous anolyte solution as an anolyte redox active species.

24. A nonaqueous redox flow battery (NRFB) system comprising: a catholyte in a positive half-cell separated by a separator from a negative half-cell having an anode comprising lithium, sodium, or magnesium and the catholyte comprises an ionic conductive chromophore having a solubility-enhancing ionic moiety comprising sulfur, nitrogen, and/or phosphorous and is in a nonaqueous catholyte solution as a catholyte redox active species at a concentration of at least 0.2 M.

25. The NRFB of claim 24, wherein the ionic conductive chromophore comprises a compound shown in FIGS. 4A-4R.
